(19) United States
(12) Patent Application Publication
(10) Pub. No.: US 2015/0139476 A1
(43) Pub. Date: May 21, 2015

(54) SPEAKER MOUNTING STRUCTURE

(71) Applicant: Kai Shuai Industrial Co., Ltd., Taipei (TW)

(72) Inventor: I-Hsun YU, Taipei (TW)

(73) Assignee: Kai Shuai Industrial Co., Ltd., Taipei (TW)

(21) Appl. No.: 14/085,678

(22) Filed: Nov. 20, 2013

(51) Int. Cl. H04R 1/02

(52) U.S. Cl. CPC H04R 1/02
USPC 381/386

(57) ABSTRACT

A speaker mounting structure includes a speaker body holding a speaker driver, a face panel assembly including an outer face panel having a retaining flange extending around the outer perimeter thereof and mounted at the speaker body and an inner face panel mounted within the outer face panel, and a decorative rim holding a metal mesh and having upper and lower hooks alternatively arranged around the inner perimeter thereof and respectively hooked on opposing top and bottom sides of the retaining flange of the inner face panel to secure to the decorative rim to the face panel assembly.

### BACKGROUND OF THE INVENTION

1. Field of the Invention

The present invention relates to speaker technology, and more particularly to a speaker mounting structure that enables a metal mesh equipped decorative rim to be installed in a wall-mount speaker in a convenient and low cost manner, forming a more enhanced and reliable structure.

2. Description of the Related Art In order to provide a better sound output, the speakers of a stereo system are usually separated from the stereo headunit. When a stereo system of this kind is installed in a room, the speakers are normally placed on the floor. However, this installation method occupies much the floor area of the room. In addition to the consideration of saving the floor area, people may install the speakers in the wall or ceiling in order to obtain better audio sound output effects, or due to the considerations of audio broadcast live environment.

Unlike a cabinet-based floor-mount speaker, the structure of a wall-mount speaker must be relatively simple for easy installation. FIG. 1 illustrates a conventional wall-mount speaker, which comprises a speaker driver 10 having a vibratable cone 11, a face panel 12 mounted at the top side of the speaker driver 10, and a decorative rim 14 mounted at the face panel 12 and holding therein a metal mesh 13 to form a flat speaker surface and to shield the vibratable cone 11 of the speaker driver 10.

In conventional wall-mount speakers, magnetic attraction mounting design is normally used, i.e., magnetic components are used for the connection between the decorative rim 14 and the face panel 12. However, the use of the magnetic components relatively increases the speaker manufacturing cost. Further, the magnetic attraction structure is less reliable. If a wall-mount speaker is installed in a ceiling or any wall in a downward facing position, the decorative rim can fall from the face panel after a long use. Thus, a magnetic component-based mounting structure is not durable.

### SUMMARY OF THE INVENTION

The present invention has been accomplished under the circumstances in view. It is main object of the present invention to provide a speaker mounting structure, which effectively reduces the manufacturing cost of the mounting structure.

It is another object of the present invention to provide a speaker mounting structure, which facilitates quick mounting between the decorative rim and the speaker body in the factory.

It is still another object of the present invention to provide a speaker mounting structure, which reinforces the structural strength between the decorative rim and the speaker body, prolonging the lifespan of the speaker.

To achieve these and other objects of the present invention, a speaker mounting structure of the present invention comprises a speaker body holding a speaker driver therein, a face panel assembly comprising an outer face panel mounted at the top side of the speaker body and an inner face panel mounted within the outer face panel, and a decorative rim fastened to the inner face panel and holding therein a metal mesh. Further, the decorative rim comprises an inner perimeter defining a circular center opening, and a hook structure arranged around the inner perimeter of the decorative rim within the circular center opening. The outer face panel comprises a retaining flange for engagement with the hooks of the decorative rim.

Preferably, the retaining flange extends around an upper part of the outer perimeter of the outer face panel. Further, the hook structure of the decorative rim comprises a plurality of transversely extending hooks spaced around the inner perimeter of the decorative rim for hooking on the retaining flange of the outer face panel.

Preferably, the hooks of the hook structure of the decorative rim are alternatively arranged at two different elevations around the inner perimeter of the decorative rim for hooking on the opposing top and bottom sides of the outer face panel.

Preferably, the retaining flange of the outer face panel has a beveled top guide edge.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is an exploded view of a conventional wall-mount speaker.

FIG. 2 is a top elevational view of a speaker mounting structure in accordance with the present invention.

FIG. 3 is an exploded view of the speaker mounting structure in accordance with the present invention.

FIG. 3A is an enlarged view of a part of the decorative rim shown in FIG. 3.

FIG. 3B is an enlarged view of a part of the outer face panel shown in FIG. 3.

FIG. 4 is a sectional view, in an enlarged scale, of one side of FIG. 2.

FIG. 5 is a sectional view, in an enlarged scale, of an opposite side of FIG. 4.

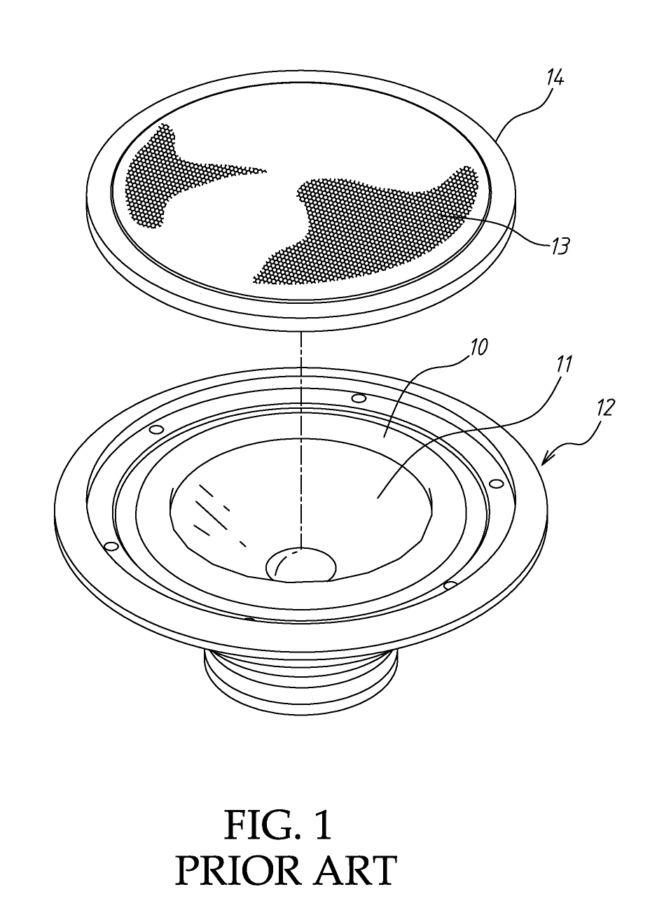

### DETAILED DESCRIPTION OF THE PREFERRED EMBODIMENT

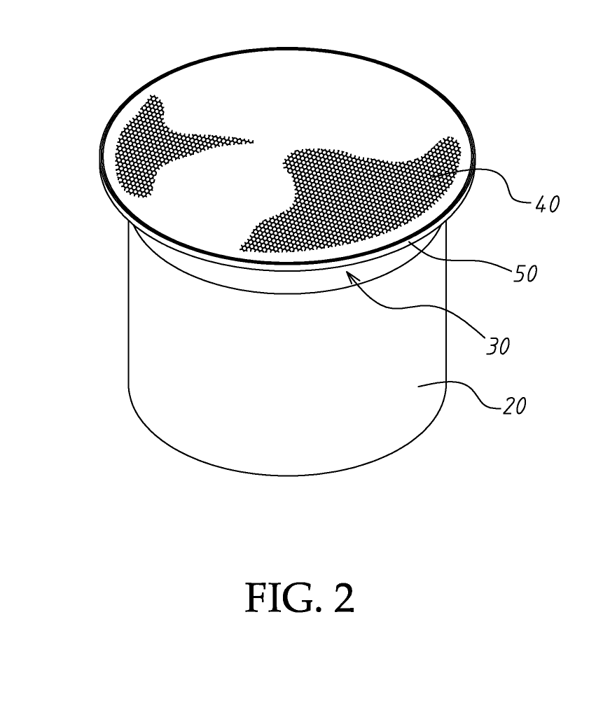

Referring to FIG. 2, a speaker mounting structure in accordance with the present invention is shown. The speaker mounting structure comprises a speaker body 20, a face panel assembly 30 located at one side, namely, the top side of the speaker body 20, and a decorative rim 50 mounted on the surface of the face panel assembly 30 and carrying therein a metal mesh 40.

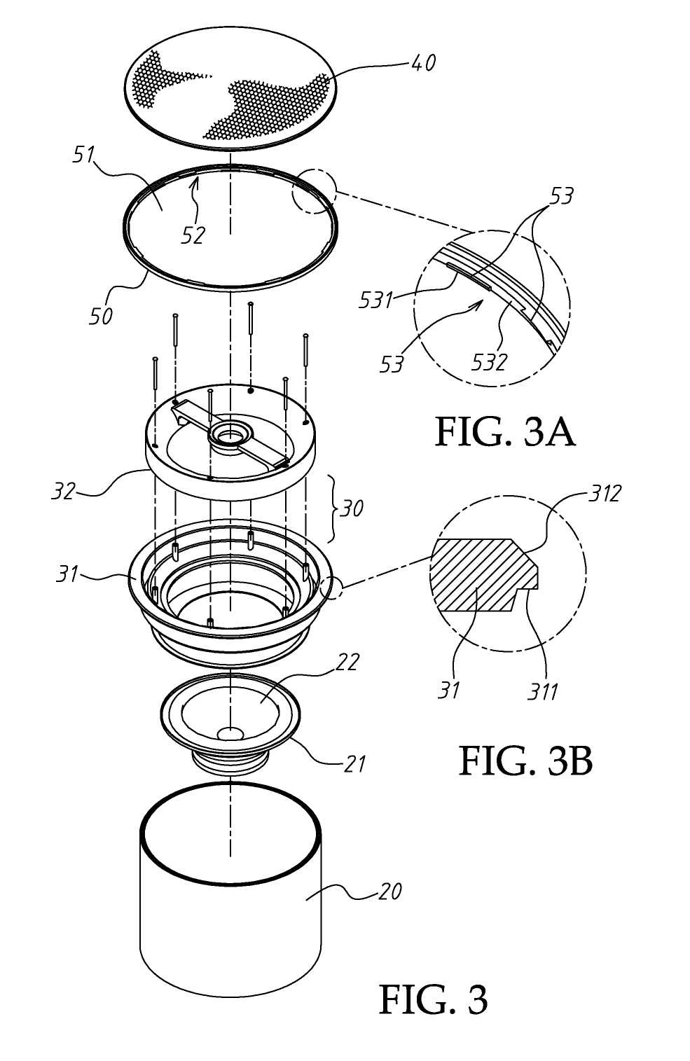

Referring to FIG. 3, the speaker body 20 has a speaker driver 21 mounted therein. The face panel assembly 30 comprises an outer face panel 31 mounted at the topmost edge of the speaker body 20, and an inner face panel 32 mounted within the outer face panel 31 and carrying therein a treble amplifier. The decorative rim 50 is assembled with the metal mesh 40 and adapted to shield the vibratable cone 22 of the speaker driver 21. The outer face panel 31 is a hollow panel having a bottom mounting flange (not shown) fastened to a mounting groove (not shown) in the top side of the speaker body 20. The inner face panel 32 is affixed to the inside of the outer face panel 31 with, for example, screws. The main feature of the present invention is that the decorative rim 50 comprises a hook structure; the face panel assembly 30 comprises retaining structure for securing the hook structure of the decorative rim 50 directly and rapidly.

According to the present preferred embodiment, the aforesaid retaining structure of the outer face panel 31 of the face panel assembly 30 is a retaining flange 311 extending around an upper part of the outer perimeter of the outer face panel 31 (see FIG. 3B). The retaining flange 311 has a beveled top guide edge 312. The decorative rim 50 is a circular ring plate defining a circular center opening 51. The aforesaid hook structure of the decorative rim 50, referenced by 53, comprises a plurality of lower hooks 531 and upper hooks 532 alternatively arranged around the inner perimeter 52 of the decorative rim 50 at two different elevations (see FIG. 3A). In this embodiment, the lower and upper hooks 531;532 are transversely extended short hooks arranged at two different elevations so that a retaining space is defined the lower hooks 531 and the upper hooks 532.

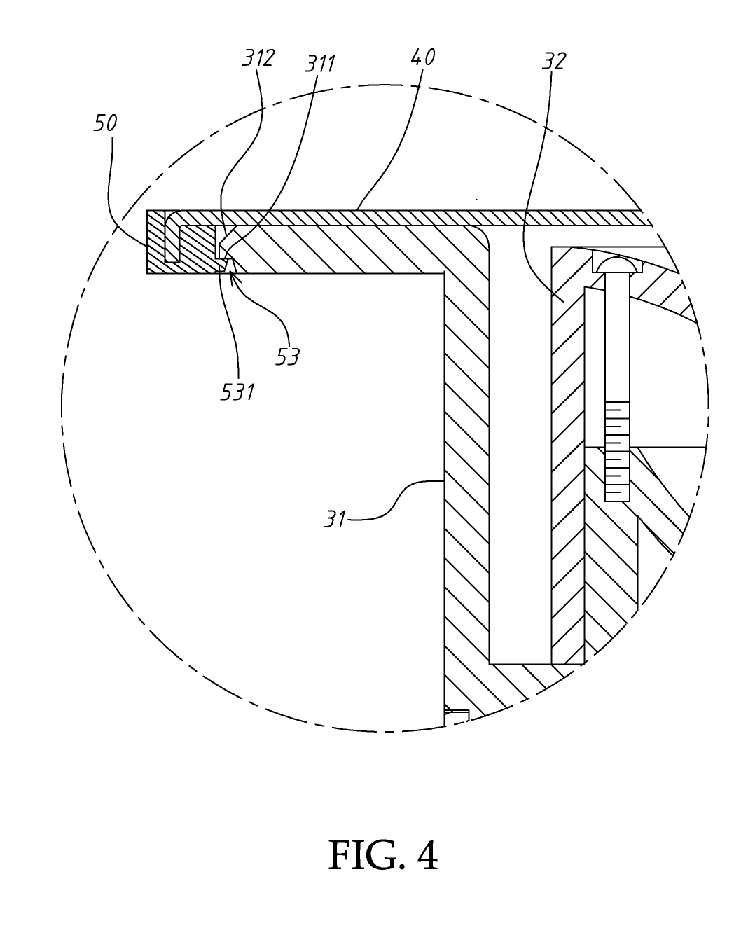

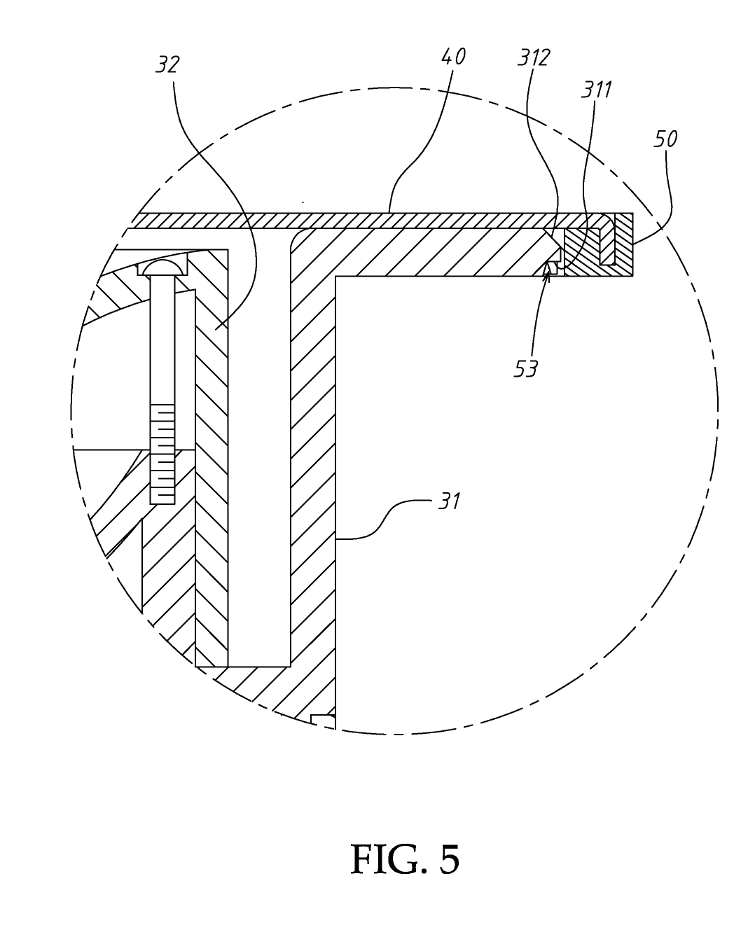

Referring to FIGS. 4 and 5 and FIG. 3 again, after installation of the metal mesh 40 in the decorative rim 50, the decorative rim 50 is directly attached to the face panel assembly 30 by forcing the lower hooks 53 of the decorative rim 50 over the beveled top guide edge 312 of the retaining flange 311 of the outer face panel 31 to the bottom side of the retaining flange 311 to have the upper hooks 532 be stopped at the top side of the retaining flange 311.

The speaker mounting structure in accordance with the present invention eliminates the use of any magnetic materials, saving the speaker manufacturing cost. Simply by giving a downward pressure to the decorative rim relative to the face panel assembly, the decorative rim can then be rapidly installed. Further, the engagement between the upper and lower hooks of the decorative rim and the retaining flange of the outer face panel also reinforce the structural strength of the whole structure, prolonging the speaker lifespan.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A speaker mounting structure, comprising:
a speaker body holding a speaker driver therein;
a face panel assembly mounted at a top side of said speaker body, said face panel assembly comprising an outer face panel mounted at said top side of said speaker body and an inner face panel mounted within said outer face panel; and
a decorative rim fastened to said face panel assembly and holding therein a metal mesh;
wherein said decorative rim comprises an inner perimeter defining a circular center opening, and a hook structure arranged around the inner perimeter of said decorative rim within said circular center opening; said outer face panel comprises a retaining flange for engagement with said hooks of said decorative rim.

2. The speaker mounting structure as claimed in claim 1, wherein said retaining flange extends around an upper part of an outer perimeter of said outer face panel; said hook structure of said decorative rim comprises a plurality of transversely extending hooks spaced around the inner perimeter of said decorative rim for hooking on said retaining flange of said outer face panel.

3. The speaker mounting structure as claimed in claim 2, wherein said hooks of said hook structure of said decorative rim are alternatively arranged at two different elevations around the inner perimeter of said decorative rim.

4. The speaker mounting structure as claimed in claim 2, wherein said retaining flange of said outer face panel has a beveled top guide edge.

5. The speaker mounting structure as claimed in claim 3, wherein said retaining flange of said outer face panel has a beveled top guide edge.
